(19) United States
(12) Patent Application Publication
(10) Pub. No.: US 2017/0100695 A1
(43) Pub. Date: Apr. 13, 2017

(54) System and Method for Scrubbing Contaminated Gas with a Glycerol Solution

(71) Applicant: Whole Energy Fuels Corporation, Bellingham, WA (US)

(72) Inventors: Orion Lekos, Bellingham, WA (US); Atul Deshmane, Bellingham, WA (US)

(73) Assignee: Whole Energy Fuels Corporation, Bellingham, WA (US)

(21) Appl. No.: 15/388,900

(22) Filed: Dec. 22, 2016

Related U.S. Application Data
(63) Continuation of application No. 14/199,904, filed on Mar. 6, 2014.
(60) Provisional application No. 61/773,749, filed on Mar. 6, 2013.

(51) Int. Cl. B01D 53/14; B01D 53/73; B01D 53/86

(52) U.S. Cl. CPC B01D 53/1493; B01D 53/8671; B01D 53/8621; B01D 53/8612; B01D 53/8668; B01D 53/1475; B01D 53/1468; B01D 53/73; B01D 53/1487; B01D 2257/304; B01D 2257/102; B01D 2257/504; B01D 2257/556; B01D 2257/80; B01D 2255/2027; B01D 2255/2022; B01D 2252/202; B01D 2252/602

(57) ABSTRACT

Both a system and a method for scrubbing a contaminated gas stream with a glycerol solution are disclosed. The system includes a contaminated gas stream in need of purification, along with a column which receives the contaminated gas stream. A glycerol solution is also received by the column and is used to scrub the contaminated gas stream in the column. The glycerol solution is used to reduce at least three contaminants from the gas stream, and includes greater than 50% glycerol and less than 98% glycerol. In one embodiment, the glycerol solution includes between 0.5% to 10% salts, wherein the salts are sodium based, potassium based or a combination thereof. The salts act catalytically to convert glycerol and carbon dioxide to glycerol carbonate.

### RELATED APPLICATIONS

This application (Attorney's Ref. No. P218976) is a continuation of U.S. patent application Ser. No. 14/199,904 filed Mar. 6, 2014, currently pending.

U.S. patent application Ser. No. 14/199,904 claims benefit of U.S. Provisional Application Ser. No. 61/773,749 filed Mar. 6, 2013, now expired, the contents of which are incorporated herein by reference.

### FIELD OF THE INVENTION

The present invention relates generally to scrubbing contaminated gas and, in particular, relates to scrubbing contaminated gas with a glycerol solution.

### BACKGROUND OF THE INVENTION

Currently, in gas scrubbing systems where more than just carbon dioxide and nitrogen are desired to be reduced (i.e., removed either partially or completely) from a contaminated gas stream, multiple systems are needed to scrub (reduce) the contaminated gas stream. For example, a contaminated gas coming from an anaerobic digester contains contaminants such as carbon dioxide, nitrogen, water, hydrogen sulfide and siloxanes. In order to clean such gas to a level that it is suitable to inject into a gas pipeline, each of the aforementioned contaminants would need to be reduced to acceptable amounts as specified by the pipeline company (or, in some cases, one or more regulatory authorities).

More generally, a contaminated gas stream can include a variety of contaminants including, for example, carbon dioxide, nitrogen, water, hydrogen sulfide and siloxanes. Typically, each of these contaminants (other than carbon dioxide and nitrogen which, in some cases, may be reduced in one system) requires a separate system to reduce it from the gas stream. Some of the technologies currently used for reducing each of the above contaminants are summarized below.

For both carbon dioxide and nitrogen, there are three primary technologies for reducing these gases from a contaminated gas stream. One of the most common techniques is to simply utilize water as a scrubbing fluid to reduce both carbon dioxide and nitrogen. This technique is advantageous when there is an unlimited free supply of water available, such as at a water treatment plant. However, in other instances, where the scrubbing media needs to be purchased, the reduction of carbon dioxide and nitrogen with the same media is generally frowned upon because the main gas of interest for reduction is carbon dioxide. By scrubbing nitrogen with the same media, binding sites in the media, which could be used to reduce carbon dioxide, will be occupied by nitrogen. This line of thinking has led to scrubbing designs, where reduction of each contaminant is achieved through a separate system. Accordingly, where unlimited free supply of water is not available, carbon dioxide and nitrogen may be reduced separately through systems that use pressure swing absorption or separation through selective membrane technology.

Hydrogen sulfide, due to its corrosiveness and flammability, is an important gas to reduce in (or, more preferably, eliminate from) the contaminated gas stream. Some current technologies used to reduce hydrogen sulfide are absorption of hydrogen sulfide on activated carbon, oxidation of hydrogen sulfide with air, reduction of hydrogen sulfide with metal oxides or biological hydrogen sulfide reduction.

Water is almost always found in contaminated gas streams. The two main technologies utilized to reduce it are either refrigeration of the gas to condense out the water or absorption with a material that has a high affinity for water (e.g., zeolite molecules or specialty resins).

Other trace contaminants found in contaminated gas streams that need to be scrubbed, such as siloxane, require specialty filters or membranes designed to reduce the trace contaminant.

As can be seen by the above description of the available technologies for scrubbing contaminated gas streams, each of the contaminants of interest (except for carbon dioxide and nitrogen, which may be reduced together) requires a special process for its reduction. Each of these technologies represents not only a greater complexity of system structure and operation, but also requires a significant footprint. Also, having more units of operation for cleaning the contaminated gas, requires more space for keeping spare parts and extra media to scrub the gas contaminant of interest. With each of these processes, experts may be required to be on-hand to deal with the unique problems that may be encountered with each contaminant reduction process. More units also represent a sizable capital expense, along with ongoing operations and maintenance costs.

In view of the above, it would be advantageous to develop a scrubbing technology that permits the scrubbing process to occur in a single column as a way to overcome the disadvantages of using multiple processes to scrub contaminated gas.

### SUMMARY OF THE INVENTION

The present invention is designed to address at least one of the aforementioned problems and/or meet at least one of the aforementioned needs.

Both a system and a method for scrubbing a contaminated gas stream with a glycerol solution are disclosed. In one embodiment, the system includes a contaminated gas stream in need of purification, along with a column which receives the contaminated gas stream. A glycerol solution is also received by the column and is used to scrub the contaminated gas stream in the column. The glycerol solution is used to reduce at least three contaminants from the gas stream, and includes greater than 50% glycerol and less than 98% glycerol. In one embodiment, the glycerol solution includes between 0.5% to 10% salts, wherein the salts are sodium based, potassium based or a combination thereof. The salts act catalytically to convert glycerol and carbon dioxide to glycerol carbonate. By consuming carbon dioxide to form glycerol carbonate, more carbon dioxide is able to be absorbed from the contaminated gas stream than pure glycerol alone.

In one embodiment, a gas scrubbing method is disclosed. According to the gas scrubbing method, a column is provided for receiving a contaminated gas stream. Glycerol solution is introduced into the column, and is used to reduce at least three contaminants from the gas stream as the gas stream moves through the column. The glycerol solution contains greater than 50% glycerol and less than 98% glycerol.

Other objects, features, embodiments and advantages of the invention will be apparent from the following specification taken in conjunction with the following drawings.

### BRIEF DESCRIPTION OF DRAWINGS

FIG. 1 is a simplified block diagram illustrating an exemplary embodiment of the present invention;

FIG. 2 is a schematic diagram illustrating an exemplary gas scrubbing system in accordance with one embodiment of the present invention;

FIG. 3 is a simplified block diagram illustrating exemplary uses of rich glycerol; and,

FIG. 4 is a simplified block diagram illustrating a use of glycerol for heating a desired substance.

### DETAILED DESCRIPTION

The present invention is directed to a system and method for scrubbing contaminated gas with a glycerol solution.

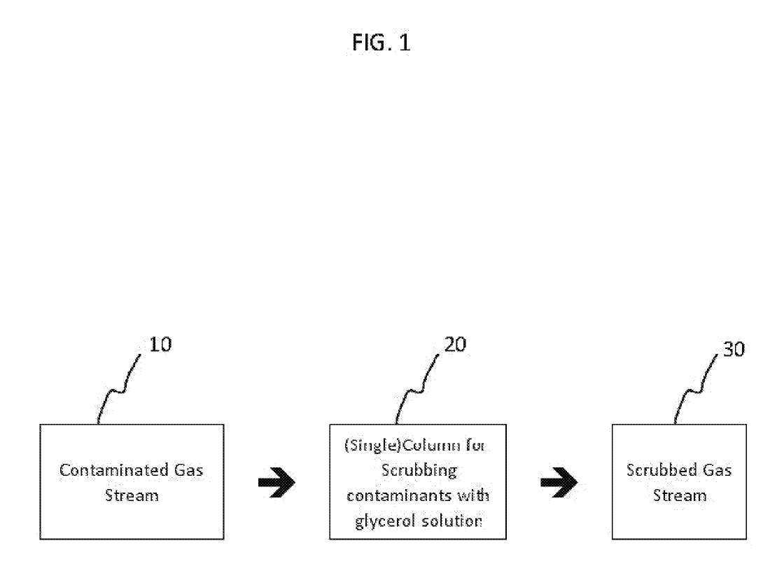

FIG. 1 is a simplified block diagram illustrating an exemplary embodiment of the present invention. Specifically, a contaminated gas stream 10 is delivered to a single column 20, where contaminants are scrubbed out of the contaminated gas stream 10 using a glycerol solution. The resulting gas stream is a scrubbed gas stream 30.

The contaminated gas stream 10 can include a variety of contaminants including, for example, carbon dioxide, nitrogen, water, hydrogen sulfide and siloxanes. As mentioned above, typically, each of these contaminants requires a separate system to reduce it from a gas stream.

The present invention includes, in one embodiment, a glycerol scrubbing solution that scrubs all the above mentioned contaminants in a single column. The scrubbing solution is comprised of glycerol that is greater than 50% pure and less than 98% pure. In one embodiment, water may be mixed with the glycerol from 2% to 50%.

In another embodiment, the glycerol solution with water includes between 0.5% to 10% salts. Such salts may include a combination of: sodium sulfate, sodium chloride, sodium phosphate, potassium sulfate, potassium chloride, or potassium phosphate. In one embodiment, the glycerol solution includes between 1% and 3.5% of the above salts.

The above salts can be introduced into the glycerol solution by a number of means. One method of adding the salts is to mix them into the glycerol solution either as solid salts until they dissolve or in a liquid solution for a quicker dissolution.

Another method is to form the salts through an acid-based neutralization reaction. This may occur when purifying glycerol produced in the biodiesel industry. Specifically, glycerol from the biodiesel industry is initially caustic because it contains residual catalysts used to make biodiesel, which are either sodium or potassium hydroxide. A step in purifying the biodiesel glycerol is to neutralize the solution with an acid such as sulfuric acid, hydrochloric acid or phosphoric acid. This will result in the following salts: sodium sulfate, sodium chloride, sodium phosphate, potassium sulfate, potassium chloride, or potassium phosphate. The salt content after neutralization of glycerol is usually between 2% and 4%.

Salts found in glycerol are produced as a byproduct of the biodiesel industry, and limit the chemical and industrial uses of the biodiesel glycerol. This is because the majority of uses for glycerol require that the salts be eliminated. Currently, the process for eliminating the salts is costly and often is not cost effective for biodiesel refiners to undergo. This results in a surplus of glycerol solution which results in inexpensive pricing.

Another source for glycerol solution that contains salts is from the soap making industry. The process by which oils are split into fatty acids and glycerol utilizes caustic sodium hydroxide. The sodium hydroxide is neutralized with one of the before-mentioned acids to neutralize it, which results in a glycerol solution containing salts in the 1% to 4% range.

The salts act to catalytically convert glycerol to glycerol carbonate in the presence of carbon dioxide. With a glycerol solution containing these salts as carbon dioxide is absorbed and scrubbed from the contaminated gas, some of the carbon dioxide will be converted to glycerol carbonate, thereby increasing the amount of carbon dioxide that is able to be scrubbed, relative to using glycerol alone. This is achieved because glycerol carbonate has the ability to scrub carbon dioxide from gas. It should be understood that the amount of salt can be modified to suit one's needs for converting the glycerol to glycerol carbonate. By creating glycerol carbonate with the glycerol solution, a higher level of selectivity is achieved with respect to reducing carbon dioxide over nitrogen. The selectivity may be adjusted by changing the salt content of the glycerol solution.

The greater than 50% to less than 98% range of purity of the glycerol is selected based on the constraints of operating a column for reducing the contaminants of interest. Pure glycerol has a viscosity similar to that of molasses. As glycerol is diluted with water, its viscosity decreases, thereby allowing a simpler operational environment. However, the greater the purity of the glycerol, the greater the amount of contaminants that can be scrubbed with less glycerol solution. On the other hand, above 98% purity, the cost of the glycerol increases such that it no longer becomes economically feasible to use glycerol as a gas scrubbing solution. One possessing glycerol of a purity of greater than 98% would be financially better off selling the glycerol in the commodities market, rather than using it in this industrial process.

Referring back to FIG. 1, the scrubbed gas stream 30 contains less contaminants than the contaminated gas stream 10. The levels of contaminants present in the scrubbed gas steam can be achieved by engineering the system to meet predetermined specifications.

For example, the column containing the glycerol scrubbing solution can be sized as tall as needed to achieve the desired reduction in contaminants by providing the proper residence time for the contaminated gas stream to be in contact with the glycerol scrubbing solution. If the column height must be limited, the column can be split into two or as many sections, as needed, to achieve the desired residence time. For example, a 30 foot column could be split into two 15 foot sections (or some other combination) if height is a limiting factor at a specific location.

Furthermore, the glycerol scrubbing solution can be used in conjunction with other technologies depending on the needs of the user. For example, a glycerol scrubbing column could be used as a first step for reducing a large array of contaminants as a way to increase the life span of equipment used with other more expensive scrubbing technologies. In another example, a glycerol scrubbing column could be added to the end of a gas scrubbing system to perform a final scrub, so as to reduce a wide range of contaminants that may be left in the contaminated gas stream. Alternatively, the glycerol scrubbing column could be used in any arrangement with other gas scrubbing technologies to meet the specifications of the user. These alternate arrangements are expected and anticipated.

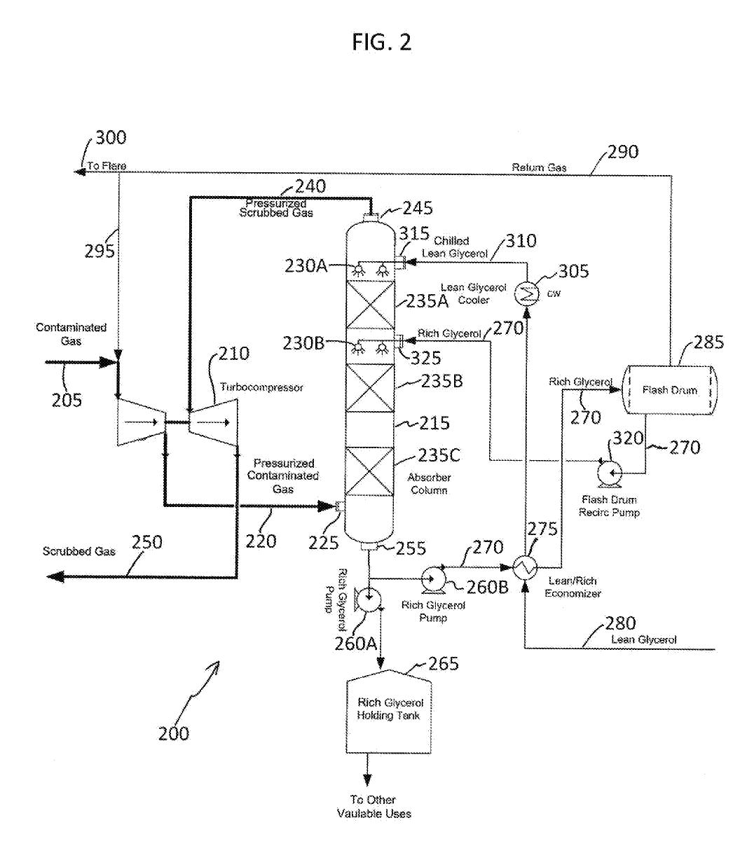

FIG. 2 is a schematic diagram illustrating an exemplary gas scrubbing system in accordance with one embodiment of the present invention.

In operation, contaminated gas 205 is introduced in the scrubbing system and is delivered to a compressor 210 to raise the contaminated gas to the operating pressure of the scrubbing column 215. The pressurized contaminated gas 220 enters absorber column 215 through a port 225 near one of the ends of the column 215. In one embodiment, the column 215 is vertically oriented. In another embodiment, the column 215 is horizontally oriented. It should be understood that other orientations are possible and anticipated.

In the vertically oriented column 215 (as shown in FIG. 2), the port 225 is located near the bottom of the column 215. In the embodiment of FIG. 2, the system 200 is designed so that the pressurized contaminated gas 220 naturally rises in the column 215. While the gas 220 is rising, glycerol solution is sprayed in a direction opposite of the gas flow via spray modules 230A, 230B. At least one of the spray modules (see, e.g., spray module 230A) will be located near an end opposite of the entry port 225 of the gas 220.

In one embodiment, glycerol is dispersed from a spray nozzle (e.g., 230A, 230B) in the form of droplets or mist within the column 215 in an attempt to increase the surface area available for contact with the pressurized contaminated gas 220. In another embodiment, the column 215 may utilize packing materials 235A, 235B, 235C to further increase the surface area available for contacting the contaminated gas 220. This increases the likelihood that the pressurized contaminated gas 220 will not go through the column 215 without coming in contact with the glycerol solution used to scrub the contaminants from the gas.

In another embodiment, the column 215 may be filled or partially-filled with liquid glycerol that the gas must pass through. In yet another embodiment, a combination of both: (a) a partially-filled column with liquid glycerol; and, (b) a portion of the column where glycerol is sprayed may be utilized to scrub the gas.

The pressurized scrubbed gas 240 exits the column 215 through a port 245. In one embodiment, pressure may be recuperated from the pressurized scrubbed gas 240 in an effort to conserve energy by: (a) pressurizing the incoming contaminated gas 205; and/or, (b) decreasing the pressure of the pressurized scrubbed gas 240. The scrubbed gas 250 (with pressure optionally reduced) is then delivered to the desired location. This may be, for example, a compression and storage system.

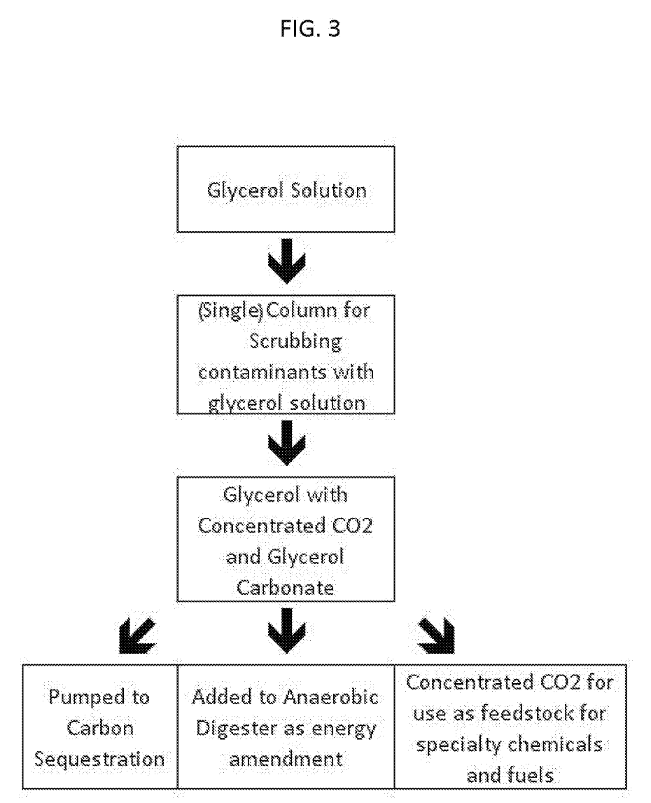

The glycerol solution used to scrub the gas, which now includes the contaminants and may include glycerol carbonate (collectively termed rich glycerol) exits the column 215 via a port 255. A predetermined percentage of the rich glycerol is directed via rich glycerol pumps 260A, 260B either to the rich glycerol holding tank 265 or to be reused (e.g., along multi-segmented path 270, as discussed below). The rich glycerol in the rich glycerol holding tank 265 may be used for a variety of other valuable purposes, some of which are shown in FIG. 3.

The rich glycerol that is directed to be reused 270 within the scrubbing system 200 may go through an economizer 275 to thereby exchange energy with the new (lean) glycerol scrubbing solution 280 being introduced to the system 200. In one embodiment, energy from the rich glycerol 270 is used to cool the incoming lean glycerol 280.

Next, the rich glycerol 270 is directed to a flash drum 285 which flashes off gas. In one embodiment, methane that may be captured by the glycerol scrubbing solution from an anaerobic digester would be flashed off along path 290 and either be mixed with incoming contaminated gas (along path 295) to the turbo compressor 210 or the return gas 290 may be flared 300. Once the system has reached equilibrium through continuous operation, by returning methane gas recovered from the rich glycerol (along path 290 and 295) in the flash drum 285, the scrubbing system 200 overall will be more efficient and have less methane gas loss.

In one embodiment, lean glycerol 280 is continually entering the system and is chilled to an appropriate temperature through a cooler or heat exchanger 305. In one embodiment, cooling water may be used to cool the glycerol. The chilled lean glycerol 310 then enters the absorber column 215 via, at least, one port 315 at an end of the column 215 (roughly) opposite to the end of the column 215 where the entry port 225 of the pressurized contaminated gas 220 is located.

As an option, rich glycerol 270 that is pumped from the flash drum 285 via flash drum recirculation pump 320 may be sprayed into the column 215 (after entering the column 215 through port 325), as a way to increase the richness of contaminants in the glycerol solution. In one embodiment, the rich glycerol 270 comes into contact with the pressurized contaminated gas 220 prior to the chilled lean glycerol 310. By reusing the rich glycerol 270, the overall amount of lean glycerol scrubbing solution needed to achieve the desired gas specifications is reduced.

Reference is again made to the entry point of the contaminated gas 205 in FIG. 2. In one embodiment, the contaminated gas 205 is cooled prior to entering the turbo-compressor system 210. Cooling of the contaminated gas has, at least, a couple of advantages. First, a large portion of condensed water will drop out, which will reduce the load on the scrubbing column 215 and prolong the life of the turbo compressor 210. Second, contaminants may be more easily scrubbed from the cooled gas (as opposed to the warmer gas) because the solubility of the contaminants in the glycerol scrubbing solution is increased when the contaminants are cooled.

Temperature adjustments may be made to the scrubbing solution to fine tune the system to preferentially scrub certain contaminants, as will be appreciated by those skilled in the art. For example, carbon dioxide is easier to scrub in a cold glycerol solution because the solubility increases.

FIG. 3 is a simplified block diagram illustrating exemplary uses of rich glycerol (e.g., which is stored in holding tank 265). The glycerol can be used to concentrate carbon dioxide for the purposes of providing: (1) a pumpable solution, with a high concentration of carbon dioxide, for carbon dioxide sequestration; (2) a concentrated solution of carbon dioxide for converting carbon dioxide to specialty chemicals, such as vehicle fuels or feedstocks for the plastics industry; and, (3) a novel route of making glycerol carbonate.

In one embodiment, the rich glycerol may be sent to an anaerobic digester for the purpose of increasing the production of methane gas. The glycerol scrubbing technology of the present invention, when coupled with an anaerobic digester, creates a valuable scenario where both the contaminated methane gas is purified and the production rate of the gas is increased by the addition of the glycerol as both a carbon source and energy source for the bacteria resident in the digester.

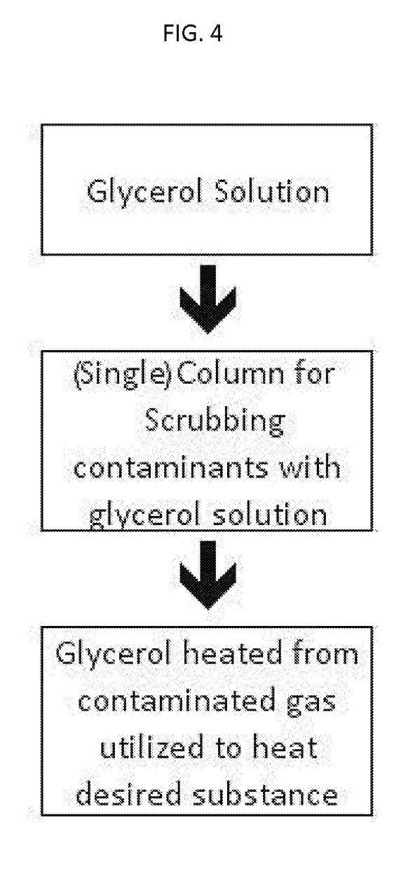

FIG. 4 is a simplified block diagram illustrating a use of glycerol (e.g., rich glycerol) for heating or cooling a desired fluid, gas or material, so as to increase energy efficiency. For example, if glycerol solution is being used to scrub carbon dioxide from a boiler exhaust system, the rich glycerol will become heated from the boiler's exhaust. In one embodiment, the rich glycerol can be used to heat water that is being fed to the boiler.

The inventors recognize that the single column approach to scrubbing multiple (at least three) contaminants could also be used in conjunction with one or more additional contaminant scrubbing processes as a way to reach specified levels of gas purity.

Several embodiments of the invention have been described. It should be understood that the concepts described in connection with one embodiment of the invention may be combined with the concepts described in connection with another embodiment (or other embodiments) of the invention.

What is claimed is:

1. A method for using at least a portion of a contaminated gas stream, the method comprising:
providing a column for receiving the contaminated gas stream;
introducing biodiesel glycerol solution into the column to obtain a scrubbed gas stream, wherein the biodiesel glycerol solution is used to reduce at least three contaminants from the gas stream as the gas stream moves through the column and wherein the biodiesel glycerol solution contains greater than 50% glycerol and less than 98% glycerol; and
adding the scrubbed gas stream to an anaerobic digester.

2. A method of claim 1, wherein the glycerol solution includes between 0.5% to 10% salts and wherein the salts are sodium based, potassium based or a combination thereof.

3. A method of claim 2, wherein the glycerol solution includes between 1% to 3.5% salts.

4. A method of claim 2, wherein the salts act catalytically to convert glycerol and carbon dioxide to glycerol carbonate.

5. A method of claim 4, wherein the glycerol carbonate that is formed has an absorption capability similar to glycerol alone, and by consuming carbon dioxide to form glycerol carbonate, more carbon dioxide is able to be absorbed from the contaminated gas stream than pure glycerol alone.

6. A method of claim 1, wherein the at least three contaminants reduced from the gas stream are selected from the group consisting of: carbon dioxide, nitrogen, water, siloxane and hydrogen sulfide.

7. A method of claim 1, further comprising multiple columns to increase residence time during which the contaminated gas stream is scrubbed by the glycerol solution.

8. A method of claim 1, wherein when coupled with an anaerobic digester, both contaminated methane gas is purified and production rates of the methane gas are increased, by the addition of the glycerol as both a carbon source and energy source for the bacteria resident in the digester.

9. A method for reducing contaminants from a contaminated gas stream, the method comprising:
introducing biodiesel glycerol solution into the contaminated gas stream such that the glycerol solution removes at least a portion of at least three contaminants from the gas stream to obtain a scrubbed gas stream, wherein the glycerol solution contains greater than 50% glycerol and less than 98% glycerol; and
adding the scrubbed gas stream to an anaerobic digester.

10. A method of claim 9, wherein the glycerol solution includes between 0.5% to 10% salts and wherein the salts are at least one of sodium based salts and potassium based salts.

11. A method of claim 10, wherein the glycerol solution includes between 1% to 3.5% salts.

12. A method of claim 10, wherein the salts act catalytically to convert glycerol and carbon dioxide to glycerol carbonate.

13. A method of claim 12, wherein the conversion of glycerol and carbon dioxide to glycerol carbonate consumes carbon dioxide from the contaminated gas stream.

14. A method of claim 9, wherein the at least three contaminants reduced from the gas stream are selected from the group consisting of: carbon dioxide, nitrogen, water, siloxane and hydrogen sulfide.

15. A method of claim 9, further comprising introducing the contaminated the glycerol solution into multiple columns and introducing the glycerol solution into the multiple columns to increase residence time during which the contaminated gas stream is scrubbed by the glycerol solution.

16. A method of claim 9, wherein the glycerol sent to the anaerobic digester functions as both a carbon source and an energy source for the production of methane gas by the bacteria resident in the digester.
